(19) United States
(12) Patent Application Publication
(10) Pub. No.: US 2008/0120901 A1
(43) Pub. Date: May 29, 2008

(54) COVER AND METHOD FOR THE PROTECTION OF NATURAL SUBSTRATES

(76) Inventor: Peter Hinsperger, Mississauga (CA)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/853,564

(22) Filed: Sep. 11, 2007

(30) Foreign Application Priority Data
Nov. 27, 2006 (CA) CA 2,569,280

(51) Int. Cl. A01G 13/02

(52) U.S. Cl. 47/20.1; 150/154

(57) ABSTRACT

A composite, flexible protective cover for turf or other natural substrates, including at least one layer having a reflective coating adapted to direct radiant heat back into the substrate.

This application claims priority on Canadian Patent Application Serial No. 2,569,280 filed on Nov. 27, 2006.

### FIELD OF THE INVENTION

The present invention relates to a method and cover for protecting outdoor grass areas, and in particular to a method and cover for covering an area of natural grass or the like substrate with an improved insulating cover, having heat reflection properties, where radiant heat is redirected back to the substrate thereby optimizing temperature conditions for growing of grass, etc.

### BACKGROUND OF THE INVENTION

There are various methods and products well known in the art which attempt to protect exterior grass and turf from desiccation, winter kill and the like by covering an area to be protected. For example, woven insulated covers are known which are used in preserving and protecting grassed areas from winter kill. At present, while there are various types of air and water permeable products on the market, none of those products are very effective to radiant heat or to enhance earth temperatures and promote early development of e.g. over-winter grasses or turf.

### SUMMARY OF THE INVENTION

According to one aspect of the present invention there is provided an improved protective cover, suitable for use in the above described fields, having heat reflective properties adapted to impart improved temperature conditions to the covered surfaces.

In a preferred embodiment of the present invention, the protective material is a flexible continuous sheet of thermoplastic material which may be provided with suitable stabilizing additives conventional in the industry as represented by ultraviolet stabilizers, extenders, anti-oxidants and the like.

Desirable properties exhibited by the products of the present invention are that the cover includes heat reflection or radiant heat properties to permit enhanced substrate conditions together with the fact that the protective cover is moisture impermeable. The cover is able to retain moisture therebeneath the protective cover without permitting the same to substantially evaporate. In a like manner, the product of the present invention prevents the passage of atmospheric air or gas through the cover from penetrating to any extent through the protective cover. This aspect of the present invention is particularly suitable in the application of the protective cover for use as a turf or field cover.

In accordance with one aspect of the present invention, there is provided a protective cover for natural substrates, comprising a first water impermeable layer, having first and second major surfaces, wherein one of the major surfaces is of a colour adapted to radiate heat, a second insulating layer positioned on the other of the major surfaces of the first layer opposite to the coloured major surface, and a third water impermeable layer having first and second major surfaces, positioned adjacent to the second layer.

In accordance with another aspect of the present invention, there is provided a method of protecting or enhancing turf, lawns, gardens or like substrates comprising applying to the substrate the protective cover noted above, in which the heat reflective portion of the cover is in facing relationship to, or in contact with, the substrate.

When the protective cover is in use in the above described field, desirably the thermoplastic material made of any suitable material such as a polyolefin, the preferred polyolefin being a polyethylene or polypropylene (or a copolymer). The coating can be made of the same or a different polyolefin compatible with the polymer of the other components.

The thickness of the material used in the present invention for the above is not critical per se, as long as the product remains flexible and to the extent that water is not able to permeate the surface. For various types of applications, it may be desirable to provide a border surrounding the sheet material to provide an integral product. Typically, preferred materials are thermoplastic in nature and by way of example such materials may be formed from a polyolefin such as polyethylene, polypropylene, copolymers, etc.

With respect to the radiant heat function of the solid membrane, such characteristics may be achieved by either selecting a thermoplastic material which has the capability of radiating heat back into the substrate (using selected additives in the material) or alternatively, by utilizing a colouring agent of a suitable characteristic which reflects the energy emitted from substrate, for example, by applying a colouring agent to the surface area from the normal light spectrum having heat specular properties such as silver, grey or other similar colours.

As otherwise outlined herein, heat reflection properties for the covering materials of the present invention, can also be varied by different means such as using concentrated or strong colours.

As otherwise outlined herein, the present invention can be used in various climates and under varying conditions. For example, depending on its intended application, the protective cover may optimally find use in colder climates as the solid membrane and silver colour for reflecting radiant heat back into the substrate permits maximum amounts of heat retained in the substrate.

The products of the present invention are particularly suitable for use on lawns, golf greens, or other turf applications where it is desired to control and enhance the ambient temperature of the turf or like surface. By way of example, golf greens frequently employ protective covering layers for wintering purposes; by utilizing the cover of the present invention, not only is moisture prevented from reaching the substrate, but due to the heat reflective layer, heat can be retained within the substrate, particularly for Spring-time use. Likewise the heat temperature of the substrate can be enhanced due to the heat reflective layer of the product and its function of reflecting or radiating heat from the substrate back into the same. It will be obvious to those skilled in the relevant art that different degrees of heat radiation can be achieved for different purposes in the products of the present invention to permit products to be tailored for different applications and locations.

### BRIEF DESCRIPTION OF THE DRAWINGS

Having thus generally described the present invention, reference will now be made to the accompanying drawings as follows:

FIG. 1 is a perspective view of the cover of the present invention, which illustrates the three layer composite protective cover; and

FIG. 2 is a perspective view of the present invention in use over a substrate.

### DETAILED DESCRIPTION OF THE PREFERRED EMBODIMENTS

The cover of the invention is particularly suitable for protecting environmentally sensitive areas, such as turf or grass areas where, for example, selected portions of such turf or grass must be protected. In accordance with a preferred embodiment, there is provided a flexible continuous sheet for use as protective cover for artificial and natural substrates, such as turf or grass areas, which must be protected from the elements. Such areas may include, but are not limited to, athletic fields (such as natural grass baseball, football or soccer fields where the infield may be a specially groomed surface), golf courses (where golf greens are maintained to higher standards compared to the balance of the playing area), or other similar type applications (i.e. agricultural applications). In such areas, diverse types of grass or vegetation may be used compared to adjacent areas, and various types of chemical treatments from fertilizers to herbicides may be used in order to maintain such areas at certain standards.

In accordance with a first preferred embodiment of the present invention, the cover includes a three ply layered cover which is adapted to be placed over a substrate to be protected, for example as a protective winter cover. The substrate upon which the protective cover is to be placed is typically a grass surface or substrate, for example a golf green or other athletic green. In a preferred embodiment, the protective cover is includes a solid or non-porous membrane, wherein at least one side is of a reflective silver or grey colour, having a middle layer or sandwiched layer of insulation such as foam, a bubble type material, straw or fibre or other similar material to act as a insulator. The third layer may be a non-porous layer or protective layer of a non-porous woven poly or vinyl material. In a preferred form, the cover is adapted to maintain the warmth within the ground while the non-porous or solid cover prevents ice or wind damage to the crown or root areas of the substrate therebeneath.

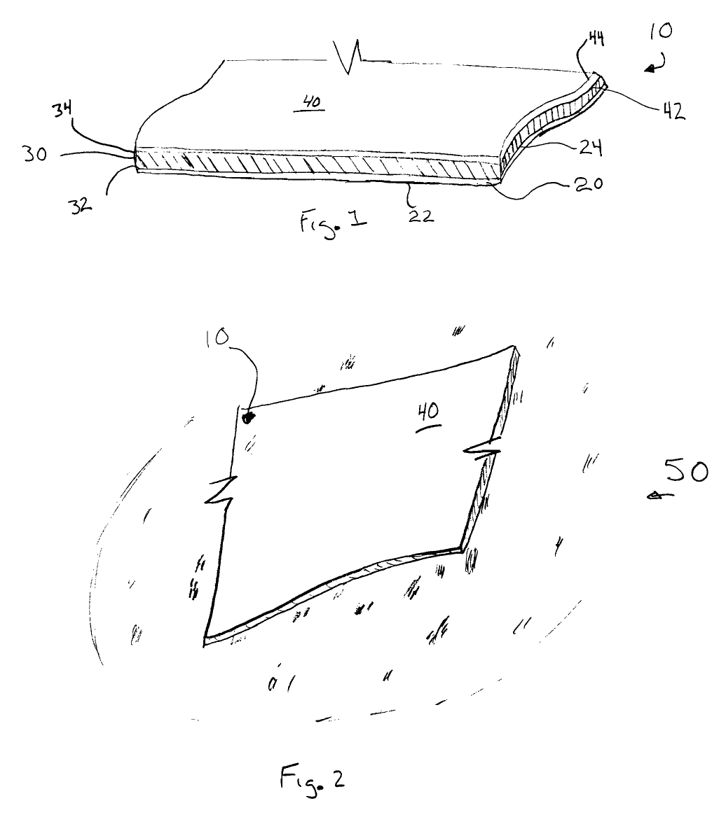

Illustrated in the accompanying drawings, the protective cover preferably is of a three ply, flexible continuous sheet (generally indicated in FIG. 1 by reference numeral 10). When viewed in an “in use” orientation (with the cover (10) in place over a substrate), such as on an athletic turf or golf green for example, there is a first layer or bottom layer (20) adapted to cover the substrate. The first layer (20), having first and second sides or major surfaces (22) and (24) respectively. Layer (20) is a non-permeable, solid membrane which is of a reflective colour, such as silver, grey or other similar colour on surface (22). The silver coating or other colour is adapted to maintain or increase the soil temperature when the turf is dormant, such as during winter. The silver colour is applied to the entire bottom or side, achieving a 100% coverage of the colour.

Positioned immediately above the first or bottom layer is a second or middle insulating layer (30). Preferably, the middle layer is an insulating layer comprised of foam, such as a closed cell foam which may be 1/32 of an inch or larger. Alternatively, the middle layer (30) may be of a bubble type material (for example, 200,000th of an inch or larger). If desired, the middle layer (30) may be a weave, fibre or straw type material.

The third or top layer (40) is positioned adjacent the second layer, and may be the same non-permeable, solid membrane as the bottom layer. The colour may be black, or silver or other similar colour as to provide a non-permeable layer to help reflect heat and/or melt the ice to help prevent ice or wind damage to the substrate therebeneath.

The layers (20), (30) and (40) may be suitably adhered, attached or joined together using convention methods and techniques.

As illustrated in FIG. 2, the protective cover (10) is shown in position over a substrate generally identified as reference numeral (50), which may be an athletic field or other area of turf such as a golf green or the like. As illustrated, the cover (10), when in use, is adapted such that the bottom or heat reflection surface faces or is in direct contact with.

In order to cover larger areas if desired, the protective cover may be suitably fastened or seamed with other covers by any suitable means. For example, the ends of the cover (10) may be overlapped and stitched or fused together. Alternatively, releasable fasteners can be used to attached several sheets together, such as Velcro, or other zipper type fastening means. In order to secure the cover to the ground, similar fasteners (not shown) can be used to releasably secure the cover to the substrate.

The present invention is directed to an insulating fabric which is adapted to radiate heat back into the ground and where the solid membrane is adapted to keep the ice from damaging the crown and root structures of the grass or substrate therebeneath. In a preferred embodiment, the protective cover (10) may be co-extruded or coated or through other conventional or known means in art to which the present invention pertains.

The protective cover (10) may be maintained or secured in place through suitable securing means, for example a plurality of elongated clips or pins. Other securing means such as hooks, wire stakes, etc. may alternatively be used to releasably secure the cover. Alternatively, cover may include other means (not shown) such as reinforced apertures (eyelets) which may also be used in combination with a pin.

As noted above, the lower layer (20) may be of a polyolefin polymer, for example, polyethylene, is provided with a colouring agent having heat reflection properties to cover 100% of the bottom layer with coloured materials such as silver or grey, etc., can be used for the material on the bottom layer (20) to provide sufficient reflection characteristics for the reflection of radiant heat.

While the invention has been described hereinabove in terms of various preferred embodiments, a person of skill in the art to which the present invention pertains will appreciate that other modifications, substitutions and alterations may be made without departing from the spirit and scope of the present invention as defined by the appended claims.

What is claimed is:

1. A protective cover for natural substrates, comprising:
a first water impermeable layer, having first and second major surfaces, wherein one of said major surfaces is of a colour adapted to radiate heat;
a second insulating layer positioned on the other of said major surfaces of said first layer opposite to the coloured major surface; and
a third water impermeable layer having first and second major surfaces, positioned adjacent to the second layer.

2. The cover according to claim 1, wherein material for the insulating layer is selected from the group consisting of foam, bubble, weave, fiber and straw.

3. The cover according to claim 1, wherein the first layer is of a polyethylene material.

4. The cover according to claim 1, wherein the colour of the first layer is a coating.

5. The cover according to claim 4, wherein the colour is silver or grey.

6. The cover according to claim 5, wherein the one of said major surfaces is of a heat radiating material.

7. The cover according to claim 1, wherein the first and third layers are of the same material.

8. The cover according to claim 1, wherein the first and third layers are of a different material.

9. The cover according to claim 1, wherein the third layer is silver or grey.

10. The cover according to claim 1, wherein the protective cover is a laminate.

11. The cover according to claim 1, wherein the protective cover is co-extruded.

12. The cover according to claim 1, wherein the protective cover is flexible.

13. A method of protecting or enhancing turf, lawns, gardens or like substrate comprising applying to the substrate the protective cover of claim 1, in which the heat reflective portion of the cover is in facing relationship to, or in contact with, the substrate.

14. The method according to claim 13, wherein material for the insulating layer is selected from the group consisting of foam, bubble, weave, fiber and straw.

15. The method according to claim 13, wherein the first layer is of a polyethylene material.

16. The method according to claim 13, wherein the one of said major surfaces is of a heat radiating material.

17. The method according to claim 13, wherein the first and third layers are of the same material.

18. The method according to claim 13, wherein the first and third layers are of a different material.

19. The method according to claim 13, wherein the protective cover is a laminate.

20. The method according to claim 13, wherein the protective cover is flexible.
